(19) United States
(12) Patent Application Publication
(10) Pub. No.: US 2005/0033569 A1
(43) Pub. Date: Feb. 10, 2005

(54) Methods and systems for automatically identifying gene/protein terms in medline abstracts

(76) Inventor: Hong Yu, Bronx, NY (US)

Correspondence Address: Leslie Gladstone Restaino;Brown Raysman Millstein Felder & Steiner LLP, 163 Madison Avenue, P.O. Box 7989, Morristown, NJ, 07962-1989, US

(21) Appl. No.: 10/915,238

(22) Filed: Aug. 9, 2004

Related U.S. Application Data
(60) Provisional application No. 60/493,970, filed on Aug. 8, 2003.

(51) Int. Cl. G06F 17/21

(52) U.S. Cl. 704/10

(57) ABSTRACT

The present invention provides computerized methods and systems for mapping biological abbreviations with biological names by processing a document that includes at least one biological abbreviation in order to identify a parenthetical expression and a phrase preceding the parenthetical expression, which are generally used as candidate abbreviations and candidate full forms of the biological abbreviations, detecting a biological abbreviation contained in the parenthetical expression or the phrase preceding the parenthetical expression, and determining whether the parenthetical expression or the phrase preceding the parenthetical expression contains a full form of the detected biological abbreviation based on a plurality of pattern matching rules designed for mapping abbreviations to their full forms.

### RELATED APPLICATION

This application claims the benefit of U.S. (Provisional) Application No. 60/493,970, entitled AUTOMATICALLY IDENTIFYING GENE/PROTEIN TERMS IN MEDLINE ABSTRACTS, filed Aug. 8, 2003, which is hereby incorporated herein by reference.

### BACKGROUND OF THE INVENTION

The present invention relates to data processing. More particularly, the present invention relates to methods, systems, and software products for the automated extraction of information from text.

A number of rule-based, linguistic, statistical, machine-learning and hybrid approaches have been developed to mark up gene/protein terms automatically in biological text. For example, one approach applied morphological cues to identify protein terms (e.g., if a word contains uppercase letter(s) and special character(s), the word is a protein term). Another approach identified protein terms through suffixes such as—ase. Yet another approach identified non-English words as gene terms. Linguistic approaches have mainly applied part-of-speech tagging or shallow parsing to identify noun phrases, from which gene/protein terms were obtained. Hybrid approaches have combined linguistic with rule-based approaches for multi-word gene/protein term recognition. For example, one approach applied a tagger in combination with rules such as “connect non-adjacent annotations if every word between them is either noun, adjective, or a numeral” to identify multi-word protein terms, such as ras guanine nucleotide exchange factor SOS. Statistical approaches have clustered abstracts for keyword identification. Machine-learning approaches have applied naive Bayes, Hidden Markov Models, and decision trees to classify gene/protein terms. Other approaches include lookup in knowledge sources such as GenBank and SWISSPROT.

Gene and protein symbols are the abbreviations of their full names. Systems have been developed for automatic mapping between abbreviations and full forms. Those systems applied a variety of approaches including linguistic, rule and statistical methods and reported precisions from 70%-97%. Domain independent approaches may not perform ideally in a restrict domain such as biology. For example, most of the rule-based approaches do not capture ryk (for receptor tyrosine kinase related gene) since y represents tyrosine. In addition, most of the systems do not differentiate gene/protein symbols form other abbreviations and full forms.

PNAD-CSS (for “protein full name abbreviation dictionary construction support system”) extracts protein symbols and full names from MEDLINE abstracts. PNAD-CSS was built on top of PROPER, a program that used morphological features to recognize proper nouns as protein terms in biological abstracts. PNAD-CSS first identified the parentheses associated with protein terms recognized by PROPER; it then determined whether the parenthetical phrase was an abbreviation of the outer phrase. PNAD-CSS broke up words of the preceding phrase, and determined whether the parenthetical abbreviation candidate maps to the initial letters of the broken-up phrase. For example, consider the phrase “megestrol acetate (megace).” PNAD-CSS parsed “megestrol acetate” as meges trol ac etate, “which is then matched to “megace.” For example, meg, ac, and e in “megace” match the initial letter(s) of “meges,” “ac,” and “elate,” respectively. PNAD-CSS reported 95.56% recall and 97.58% precision.

PNAD-CSS has some limitations. PNAD-CSS applies morphological cues for protein term recognition. The morphological cues may also falsely identify as protein symbols other substances (e.g., LSD-25 for lysergic acid diethylamide), cell types (e.g., BILK-21 for baby-hamster kidney-cell line), procedures (e.g., PCR for polymer=chain reaction) as well as clinical syndromes and diseases (e.g., CHF for congestive heart failure). This is because many abbreviations that are not gene/protein symbols consist of upper-case letters and numbers. The PNAD-CSS pattern-matching rules also did not contain special rules for protein full names (for example, y represents tyrosine).

### SUMMARY OF THE INVENTION

In one aspect of the invention, a method for mapping biological abbreviations with biological names is provided which includes processing a document comprising at least one biological abbreviation to identify a parenthetical expression and a phrase preceding the parenthetical expression which are used as a candidate abbreviation and a candidate full form of the biological abbreviation, detecting a biological abbreviation contained in one of the parenthetical expression and the phrase preceding the parenthetical expression, and determining whether one of the parenthetical expression and the phrase preceding the parenthetical expression contains a full form of the detected biological abbreviation based on a plurality of pattern matching rules designed for mapping abbreviations to their full forms.

In another aspect of the invention, a method for mapping biological abbreviations with biological names is provide which includes processing at least one document comprising at least one biological abbreviation, parsing the document into sentences and identifying sentences that contain parentheses, parsing at least one of the sentences that contain parentheses into a first component comprising text within the parentheses and a second component comprising text preceding a left parenthesis, detecting a biological abbreviation contained in one of first component and the second component, and determining whether one of the first component and the second component contains a full form of detected biological abbreviation using a plurality of pattern matching rules designed for mapping abbreviations to their full forms.

In another aspect of the invention, a method for mapping biological abbreviations with biological names is provided that includes processing at least one document comprising at least one biological abbreviation, parsing the document into sentences and identifying sentences that contain parentheses, parsing sentences that contain a plurality of parentheses pairs into at least three components where text preceding and within the parentheses in each component incorporate candidate abbreviations and candidate full forms, detecting at least one biological abbreviation contained in one of the at least three components, and determining whether one of the at least three components contains a full form of detected biological abbreviation using a plurality of pattern matching rules designed for mapping at least one of gene and protein abbreviations to their full forms.

Additional aspects of the present invention will be apparent in view of the description which follows.

### BRIEF DESCRIPTION OF THE FIGURES

FIG. 1 is a chart that plots the relation of the numbers of gene/protein symbols and full names that appeared in different numbers of abstracts

### DETAILED DESCRIPTION OF THE INVENTION

The present invention provides computer systems, methods, and software, e.g., AbbRE (for “abbreviation and full form recognition and extraction”), which pairs biomedical abbreviations found in at least one document with the abbreviation's full form (i.e., full names). The present invention also provides methods for mapping defined and undefined abbreviations (defined abbreviations are paired with their full forms in the articles, whereas undefined ones are not). For defined abbreviations, a set of pattern matching rules have been developed to map an abbreviation to its full form and implemented the rules into a software program, e.g., AbbRE. Using the opinions of domain experts as a reference standard, the recall and precision of AbbRE for defined abbreviations in ten biomedical articles randomly selected from the ten most frequently cited medical and biological journals was evaluated. The percentage of undefined abbreviations in the same set of articles was measured, and it was investigated whether undefined abbreviations could be mapped to any of four public abbreviation databases (GenBank LocusLink, SWISSPROT, LRABR of the UMLS Specialist Lexicon, and BioABACUS).

In one embodiment, AbbRE selects parenthetical expressions and the phrases preceding the parenthesis as candidate abbreviations and full forms. A set of the pattern-matching rules may then be applied to map abbreviations to full forms. One or more of the following rules may be included: 1) the first letter of an abbreviation matches the first letter of a meaningful word of the full form; 2) the abbreviation matches the first letter of each word in the full form; 3) the abbreviation letter matches consecutive letters of a word in the full form and 4) the abbreviation letter matches a middle letter of a word in the full form if the first letter of the word matches the abbreviation.

AbbRE has an average 0.70 recall and 0.95 precision for the defined abbreviations. It was found that an average of 25 percent of abbreviations were defined in biomedical articles and that of a randomly selected subset of undefined abbreviations, 68 percent could be mapped to any of four abbreviation databases. It was also found that many abbreviations are ambiguous (i.e., they map to more than one full form in abbreviation databases). AbbRE is therefore efficient for mapping defined abbreviations.

Abbreviations and acronyms are commonly used in biomedical literature. The names of many clinical diseases and procedures, and of common terms in the basic sciences, have widely used abbreviations. Recognizing the full forms associated with abbreviations is important for identifying the meaning of an abbreviation, which in turn facilitates natural language processing of, and information retrieval from, the literature. The present invention may be applied to computer systems, e.g., at least one computing device, with software associated therewith that when executed will perform such recognition automatically.

Two types of abbreviations appear in biomedical articles—common and dynamic abbreviations. Many common abbreviations become accepted as synonyms; for example, CHF (congestive heart failure) and CABG (coronary-artery bypass graft) are listed in standard vocabulary resources, such as the Medical Subject Headings (MeSH) and Unified Medical Language system (UMLS). Obviously, common abbreviations represent terms important in their domains.” Using common medical abbreviations as search terms for literature citations results in more relevant retrievals than does using the full forms as search terms. It was found that all 20 common medical abbreviations chosen were recognized by MEDLINE, discussed in more detail below, and all were mapped to the appropriate MeSH headings.

In contrast, dynamic abbreviations are defined by an author for convenience in only a particular article. For example, CU might represent Columbia University in one article, computer use in another, and congested udder in a third. Many articles use both common and dynamic abbreviations. Therefore, it is important that automated text processing systems recognize the meanings of both types of abbreviations.

A number of approaches may be used to identify the meanings of abbreviations in electronic articles, such as by 1) detecting abbreviations and mapping them to their full forms solely on the basis of the content of the article, and 2) detecting abbreviations and then mapping them to full forms that we obtain from abbreviation databases. The first approach is limited to those abbreviations that are defined in the article, i.e., their full forms appear in the article. The second approach may be used as an adjunct to the first to discover the full forms associated with abbreviations not so defined.

The first approach is feasible in part because many scientific journals have rules for the formation and definition of abbreviations; the most common requirement is that an abbreviation be defined on first use in the format <full form >(<abbreviation>) or <abbreviation>(<full form>). In addition, people apply many common conventions to create an abbreviation. For example, people may form an acronym from the initial letter of the primary words of a phrase (e.g., NLP for natural-language processing); they may create an abbreviation using meaningful portions of the words (e.g., Fig. for figure), or meaningful parts of a neoclassical compound (e.g., APT for aminopropylisothiuronium), or a combination of meaningful units or words and initial letters of component words (e.g., mAb for monoclonal antibody). Therefore, we can use pattern recognition methods using pattern-matching rules to find abbreviations and to map them to their full forms within an article.

Other researchers have developed automatic methods for identifying abbreviations and pairing those abbreviations with a definition. Hisamitsu and Niwa identified technical terms—including company names, organization names, law names, and theory—names from Japanese newspaper articles, They first, through bi-gram statistics, selected phrases associated with parentheses (the parenthetical phrase and the outer phrase co-occur more frequently than random); they then applied a set of simple rules to identify whether the parenthetical phrase was an abbreviation of the outer phrase. For example, a rule indicated that a phrase was an abbreviation of a full form if the letters of the phrase appeared in order in the full form. Their evaluation of this approach demonstrated 97 percent precision.

KEP (for knowledge extraction program) is another system that identifies paired abbreviations and full forms. The system first detects a word as an abbreviation when all the letters of the word are upper case. It then fragments the sentence that contains the abbreviation into a set of t-word strings, where t ranges from 1 to n+3 (n is the total number of letters in the abbreviation). For each string, KEP takes the initial letter of each word and forms a shortened string. KEP considers the string as a full form of the abbreviation if the letters of the shortened string match over 70 percent of the letters of the abbreviation. KEP has been shown to have 73 percent recall and 84 percent precision.

PNAD-CS5 (for Protein Name Abbreviation Dictionary Construction Support System) extracts paired a protein name (e.g., eukaryotic initiation factor 2) and its abbreviation (e.g., elf2) from biological abstracts. The program was built on top of PROPER, a program that uses morphologic features (e.g., uppercase letters combined with numbers) to recognize proper nouns as protein terms in biological abstracts. For example, PROPER recognizes “ear as a protein term because it contains a numeric value (in this case, “2”).

PNAD-CSS also uses TEXS2, a program that breaks up words in a phrase into several components. PNAD-CSS first finds the parentheses associated with the protein terms recognized by PROPER; it then determines whether the parenthetical phrase is an abbreviation of the outer phrase. PNAD-CSS uses TEXS2 to break up words of the preceding phrase and determines whether the parenthetical abbreviation candidate maps to the initial letters of the broken-up phrase.

Consider the phrase megestrol acetate (megace), for example. TEX82 parses “megestrol acetate” as “meges trol ac etate,” which PNAD-CSS then matches with “megace” because it matches the initial letters of the components (e.g., “meg,” “ac,” and “e” in “megace” match the initial letter(s) of “meges,” “ac,” and “elate,” respectively). PNAD-CSS had 95.56 percent recall and 97.58 percent precision.

All three systems have limitations that may affect their use in the biomedical domain. Hisamitsu and Niwa's approaches rely on statistical significance of the two terms that are associated with parentheses; the approach might miss abbreviations and full forms that are newly introduced into the literature. KEP considers as abbreviations only words in which all letters are uppercase, and matches only letters (not other symbols, such as numbers). These restrictions do not apply to many biomedical abbreviations, which often consist of both upper- and lowercase letters (e.g., Ab for Antibody) and include numbers (e.g., Igl for lateral gasfrocnemius 1). PNAD-CSS was built on top of PROPER and may miss paired abbreviations and full forms that were not recognized by PROPER.

Hisamitsu and Niwa's approaches and KEP have not been evaluated in the biomedical domain. PNAD-CSS was developed to extract protein names and their abbreviations; no one has yet evaluated whether it can be generalized to recognize other full forms and associated abbreviations in other settings or in whole articles rather than abstracts. Mapping abbreviations in whole articles may be more challenging since the linguistics of an article body may be more sophisticated than its abstract.

Hisamitsu and Niwa's approaches, KEP, and PNAD-CSS all apply sets of pattern matching rules for mapping an abbreviation to its full form. However, Hisamitsu and Niwa's pattern-matching rules are preliminary and can introduce false matches, For example, column would be falsely recognized as an abbreviation of Columbia University, because the letters of column appear in order in Columbia University.

KEF applies the n-gram approach to identify full forms and therefore may have difficulty in identifying a full form boundary. For example, KEP may mistake the full form of BPI as bactericidal permeability increasing instead of bactericidal permeability increasing protein, since the initial letter of protein is not in the abbreviation. In addition, KEP's, pattern-matching rules consider only the initial letters of words in a phrase; they may miss those abbreviations that rep-resent the middle letters of words (e.g., APT for amino propylisothiuronium).

KEP does apply approximate matching (i.e., if the string formed from initial letters of a sequence of words matches over 70 percent of the abbreviation, KEP considers the sequence of words as its full form), and the approximation may indirectly include some matches from the middle letters. It is not clear how suitable the approximation is in the biomedical domain, however.

PNAD-CSS relies on TEX82 to break up words into components; therefore, TEX82 needs to be evaluated to determine how well it breaks words in biomedical fields other than protein science.

To date, Hisamitsu and Niwa's approaches and KEP have been evaluated by the developers, but not by independent researchers. PNAD-d5.5 was evaluated by a person who was not a biomedical specialist. The evaluation of PNAD-CSs also assumed that PROPER had 100 percent recall and 100 percent precision in identifying protein terms and that PNAD-CSS recognized a correct abbreviation as an abbreviation of a protein name even if the abbreviation was not. Therefore, PNAD-CSS's recall and precision may be lower than reported.

The AbbRE program differs from the three approaches just described. AbbRE was developed to handle full biomedical articles. In one embodiment, AbbRE searches for parenthetical expressions for paired abbreviations and full forms. In another embodiment, AbbRE does not break up words into components; it relies only on a set of pattern matching rules for mapping an abbreviation to its full form. The pattern-matching rules are generalized from the common conventions by which people create an abbreviation. Any method that attempts to define abbreviations solely on the basis of information in the articles in which they appear obviously cannot interpret abbreviations that are undefined in those articles. Accordingly, in one embodiment, AbbRE maps undefined abbreviations using externally developed abbreviation databases.

Because people recognize that understanding abbreviations is important for information retrieval, there are many such databases. They include databases containing protein- and gene-name abbreviations (e.g., Gen-Bank LocusLink, SWISSPROT, Yeast Genome Database, and Genome Database Bark), common-abbreviation databases such that those used for the natural language processing lexicon (e.g., LRABR), and those created for computer linkages between abbreviations among different disciplines (e.g., BioABACUS). We chose to use Genbank LocusLink, SWISSPROT, LRABR from the UMLS Specialist Lexicon, and BioABACUS because they are maintained by domain experts and many of them are supported by government organizations; they also have a good coverage.

Genbank LocusLink is a Web source developed recently by the National Center for Biotechnology Information (NCBI), to facilitate retrieval of gene-based information and to provide a reference sequence standard. LocusLink contains a data-base (stored in the file LL out) of 54,719 genes; it lists both their abbreviations and their full forms.

SWISSPROT is an annotated protein-sequence data-base established in 1986 and maintained collaboratively by the Swiss Institute for Bioinformatics (SIB) and the European Bioinformatics Institute (EBD. SWISSPROT currently has 88,800 protein abbreviations and their full forms.

The LRABR file of more than 10,000 abbreviations is part of the UMIS SPECIALIST lexicon. The National Library of Medicine (NLM) built the UMLS Knowledge Sources to improve the ability of computer programs to “understand” the biomedical meaning of user inquires and to use this understanding to retrieve and integrate relevant machine-readable information for users. The UMIS SPECIALIST lexicon is an English-language lexicon of biomedical terms from a variety of sources, including MEDLJNE citation records and the UMLS Metathesaurus.

BioABACUS is a public database of common abbreviations that creates computer linkages between abbreviations and their meanings. The database was generated manually from literature and from other databases; it covers only biotechnology and computer science. It contains More than 6,000 abbreviations and their full forms.

Our study had three components development of AbbRE, evaluation of AbbRE, and determination of the percentage of undefined abbreviations that could be mapped to entries in each of four abbreviation databases (GenBank, LocusLink, SWISSPROT, LRABR, and BioABACUS).

Development of AbbRE—a set of rules for matching biological abbreviations with their full forms have been developed that define a well-formed abbreviation. The rules were generalized from review of all the abbreviations and their full forms in 200 Science articles, a randomly selected sub-set of articles related to signal-transduction pathways. Table A summarizes rules according to one embodiment of the invention.

By implementing these rules in a computer code (Perl), AbbRE (abbreviation recognition and extraction program), maps abbreviations and full forms from computer-readable versions of scientific articles and produces as output, paired abbreviations and full forms. AbbRE generally performs its work in four steps.

TABLE 1
Pattern-matching Rules for Mapping an Abbreviation to Its Full Form

| Rule | | Example |
|---|---|---|
| 1. | The first letter of an abbreviation | Unified Medical |
| | matches the first letter of the | Language System |
| | meaningful word of the full form. | (UMLS) |
| 2. | The abbreviation matches the | tumor necrosis |
| | first letter of each word in the full form. | factor (TNF) |
| 3. | A word in the full form can be skipped | extracellular |
| | if the abbreviation letter matches | signal-regulated protein; |
| | the first letter of the following | dense 1 (ERK1) |
| | word. | |
| 4. | The abbreviation letter matches | insulin receptor (InR) |
| | consecutive letters of a word in the | |
| | full form. | |
| 5. | The abbreviation letter matches the | cysteine-rich |
| | last letter of a word in the full form | domains (CRDs) |
| | if the letter is an s and if the first letter | |
| | of the word matches the abbreviation. | |
| 6. | The abbreviation letter matches a middle | Immunoglobutin G1 |
| | letter of a word in the full form if the | (IgG1) |
| | first letter of the word matches the | |
| | abbreviation. | |
| 7. | The rules are iteratively applied | |
| | in the order 2, 3, 4, 5,and 6 until the | |
| | abbreviation is completely matched. | |

Step 1: Parenthesis Detection—AbbRE preprocesses the article or document to remove html tags and certain parentheses that are not associated with abbreviations, such as parentheses containing only numbers, numbers with percentage symbol (%), and certain keywords—fig, table, Jane, pH, page, inside, inset, and column. After preprocessing, AbbRE parses the article into sentences and selects for further analysis the remaining sentences that contain parentheses.

Step 2: Parenthesis Separation—Using the selected sentences from step 1, AbbRE first parses a sentence into components by the right parenthesis; for each component it then pairs the phrase after the left parenthesis (the inner phrase) (first component) with the phrase preceding the left parenthesis (the outer phrase) (second component). For example, in the sentence “Transmembrane domain (TM), DD (death domain), and the negative regulatory domain (NR) are labeled”, the three paired outer and inner phrases for further analysis are Transmembrane domain (TM), DD (death domain), and the negative regulatory domain (NR).

Step 3: Biological Abbreviation Detection—Using the selected paired phrases from step 2, AbbRE partitions any inner phrase that contains certain punctuation marks, such as a semicolon or comma, and extracts the part of the inner phrase to the left of the punctuation mark for further analysis. For example, with TNFR1-associated death domain protein (TRADD; Hsu et al., 1995,1996a), AbbRE parses the inner phrase, TRADD; Hsu et al., 1995,1996a, and extracts TRADD as a new inner phrase for further analysis.

AbbRE assumes that an abbreviation consists of only one word and recognizes that an abbreviation is shorter than its full form. Either an outer phrase or art inner phrase may contain an abbreviation or a full form. If the inner phrase contains more than one word, then AbbRE assumes that the inner phrase contains a potential full form and the word right before the left parenthesis is the potential abbreviation. For example, in DD (death domain), AbbRE recognizes the inner phrase death domain as containing a potential full form, and the word right before the left parenthesis, DD, as a potential abbreviation.

If an inner phrase contains only one word, then the inner phrase is judged to be an abbreviation and the outer phrase is judged to contain the full form. It is possible, however, that a full form consists of only one word. For example, the full form of the abbreviation T is temperature. To recognize this type of abbreviation, AbbRE applies the following strategies.

When an inner phrase contains only one word and the number of letters in the inner phrase is more than the number of letters in the word right before the left parenthesis, AbbRE not only considers the inner phrase as a potential abbreviation and the outer phrase as a potential full form, but also considers the inner phrase as a potential full form of the word right before the parenthesis. In the amount of Ab (antibody), AbbRE not only considers the inner phrase, antibody, as a potential abbreviation, with its full form contained in the outer phrase, the amount of Ab, but also considers antibody as a potential full form of Ab.

Step 4: Full Form Detection—AbbRE applies the pattern-matching rules that we developed (Table A) to map an abbreviation to its full form. Since the first letter of the abbreviation always corresponds to the first letter of the first meaningful word of the full form, AbbRE selects the words in a potential full form when these words begin with the first letter of the potential abbreviation. Then AbbRE extracts a list of strings of words starting from the selected word to the end of the phrase, and recognizes each string as a potential full form.

In death domain (DD), for example, both death and domain are marked up (because both words begin with a letter d, which is the first letter of the potential abbreviation D); AbbRE recognizes two strings—domain and death domain—as potential full forms.

TABLE B
Evaluation Results of Defined Abbreviations

| | | No. Correct | No. Incorrect | | Precision (95% |
|---|---|---|---|---|---|
| Domain | Expert | Abbreviations | Abbreviations | Recall (95% CI) | CI) |
| Medical | Expert 1 | 39 | 0 | 0.87 (0.82-0.92) | 1.00 |
| Medical | Expert 2 | 39 | 0 | 0.87 (0.82-0.92) | 1.00 |
| Medical | Expert 3 | 32 | 0 | 0.71 (0.64-0.78) | 1.00 |
| Medical | AbbRE | 35 | 1 | 0.78 (0.72-0.84) | 0.97 (0.94-1.0) |
| Biological | Expert 4 | 37 | 2 | 0.84 (0.78-0.90) | 0.95 (0.92-0.98) |
| Biological | Expert 5 | 36 | 3 | 0.82 (0.76-0.88) | 0.92 (0.89-0.95) |
| Biological | Expert 6 | 31 | 0 | 0.70 (0.63-0.77) | 1.00 |
| Biological | AbbRE | 27 | 2 | D.61 (0.55-0.68) | 0.93 (0.89-0.97) |
| Medical and biological | AbbRE | 62 | 3 | 0.70 (0.65-0.75) | 0.95 (0.93-0.97) |

AbbRE was executed using the remaining 40 articles (20 medical articles from five medical journals and 20 biological articles from five biological journals). The output of AbbRE consisted of defined abbreviations, their full forms, and their unique article-identification numbers as well as the sentences that contained the abbreviations and full forms. Experts were asked to judge the correctness of each abbreviation and its full form listed in the AbbRE outputs. The reference standard consisted of those abbreviations that were agreed on by two or three experts. We obtained the precision of AbbRE for medical and biological journals separately as well as for the aggregate.

Determination of the Percentage of Undefined Abbreviations That Could Be Mapped to Abbreviation Databases—a subset of the undefined abbreviations (30 from medical articles and 30 from biological articles) ere randomly selected from the reference standard and judged the existence of those abbreviations in any of four abbreviation databases (GenBank LocusLink, Sw15SPROT, LRABR, and BioABACUS). The percentages of those abbreviations that could be identified in the four abbreviation databases were further calculated individually and in combination.

A total of 46 defined abbreviations were pooled from three medical experts (experts 1 to 3) and the AbbRE, of which 45 were selected as the reference standard on the basis of agreement by two or three of the experts. A total of 51 defined abbreviations were pooled from three biological experts (experts 4 to 6) and the AbbRE, of which 44 were selected as the reference standard. Table B lists the results of the evaluation for those defined abbreviations.

For defined abbreviations, as shown in Table B, the average recall and precision of the three medical experts were 0.8 and 1.0, respectively; the recall and precision of AbbRE for medical articles were 0.78 and 0,97, respectively. Among the three medical experts, the overall agreement before and after pooled abbreviations was 0.70 and 1.00, respectively. The average recall and precision of the three biological experts were 0.79 and 0.96, respectively; the recall and precision of AbbRE for biological articles were 0.61 and 0.93, respectively. Among the three biological experts, the overall agreement before and after pooled abbreviations was 0.75 and 0.80, respectively. The recall and precision of AbbRE for both medical and biological articles was 0,70 and 0.95, respectively.

A total of 132 and 250 undefined abbreviations were selected by the experts from five medical articles and five biological articles, respectively; of which 132 and 137 were chosen as the reference standard. Therefore, the percentages of abbreviations that were defined in five medical articles, five biological articles, and both medical and biological articles were 25 percent, 24 percent, and 25 percent, respectively. The overall agreements among medical experts before and after the pooled abbreviations were 0.42 and 1.00, respectively. The overall agreements among biological experts before and after the pooled abbreviations were 0.40 and 0.66, respectively.

In another evaluation, AbbRE extracted 160 and 157 defined abbreviations and full forms from 20 medial articles and 20 biological articles, respectively, of which two or three experts agreed with 144 and 135 medical and biological abbreviations and full forms, respectively. Abbreviations selected by AbbRE on which the experts disagreed included of alternative medicine foam) and get fusion vector, eyrie was first expressed as a gstfusion protein (gst-cydr).

We noticed that 3 medical abbreviations and full forms and 14 biological abbreviations and full forms were given question marks by experts because the full forms were attached to an HTML tag (e.g., presenilin 1&nbsp was a full form of ps1). After we removed the HTML tag, all experts agreed with those abbreviations and full forms. We therefore added those abbreviations to the reference standard. Thus, the reference standard consisted of 147 and 149 medical and biological abbreviations and full forms, respectively.

The precision of AbbRE was 0.92 (95% CI, 0.90-0.94) and 0.95 (95% CI, 0.93-0.97) for medical and biological articles, respectively. The precision of AbbRE for both domains was 0.93 (95% CI, 0.92-0.94). Among the experts, the overall agreement for medical articles was 0.88; the overall agreement for biological articles was 0.94.

AbbRE failed to recognize some abbreviations and full forms selected by experts; we therefore manually mapped all the abbreviations selected by the experts and those included in the AbbRE output to their original articles and identified the causes of the failure. We found that most abbreviations that failed to be recognized by AbbRE were not associated with their full forms through parentheses. Many abbreviations were defined not in the article body but in a special section of the articles. For example, the Journal of Biological Chemistry has a special abbreviation section that include& some chemical abbreviations and full forms (e.g., Cbz, benzyloxycarbonyl) that are not defined in the articles. Some abbreviations were defined in different parts of the articles. For example, AJT, which was used in the article body of a Lancet article, are the initials of the author, Andrew J. Thompson, which appeared in the author section of the article. Other abbreviations and full forms were not suitable to be mapped by the pattern-matching rules. An example was 100 mL 0.01 M phosphate buffer and 0.9% sodium chloride [PH 7.41, With 1.0 g bovine serum albumin and 0.1 mL Tween 20 (PBA).

Determination of the Percentage of Undefined Abbreviations That Could Be Mapped to Entries in Each of Four Abbreviation Databases—30 undefined medical abbreviations and 30 undefined biological abbreviations were randomly selected from the reference standard described above, and manually identified the existence of these abbreviations in the four abbreviation databases—GenBank Locust ink, SWISSPROT, LRABR, and BioABACUS. Table C lists the numbers and percentages of these abbreviations that can be mapped to each database and to any of the four combined databases.

TABLE C
Number (Percentage) of Undefined Abbreviations from Medical
and BiologicalArticles That Can Be Mapped to Each and Any
of Four Abbreviation Databases.

| | | | Medical and |
|---|---|---|---|
| Abbreviation Database | Medical* | Biological^{†} | Biological^{‡} |
| GenBank LocusLink | 3 (10) | 4 (13) | 7 (12) |
| Swissprot | 2 (7) | 8 (27) | 10 (17) |
| LRABR | 15 (50) | 10 (33) | 25 (42) |
| Bioabacus | 6 (20) | 12 (40) | 18 (30) |
| Any of the four databases: | 17 (57) | 24 (80) | 41 (68) |

*The number (percentage) of abbreviations from medical articles that can be mapped to each database and to any of the four data-bases.
^{†}The number (percentage) of abbreviations from biological articles that can be mapped to each database and to any of the four data-bases.
^{‡}The number (percentage) of abbreviations from both medical and biological articles that can be mapped to each database and to any of the four databases.

We observed that many abbreviations were covered by more than one database. For example, EDTA (ethylenediaminetetraacetic acid) was found in both LRABR and BioABACUS, and TRADD (TNFASFIA-associated via death domain) was found in GenBank LocusLink, SWISSPROT, and BioABACUS. FELIX, 5P5S, and U test are examples of abbreviations that could not be mapped to any of the four databases.

We also observed that many abbreviations were ambiguous. Different full forms of an abbreviation could be found within a database or across databases. For example, Ltd mapped to laron-type dwarfism, leukotriene d, and long-term disability in LRABR, lightoid in GenBank LocusLink, and Long-term Depression in BiOABACUS.

AbbRE achieved reasonable overall performance (recall 0.70, precision 0.95). The results indicate that AbbRE may be a useful tool for mapping defined abbreviations. However, the overall percentage of defined abbreviations may be small (average, 25 percent). Thus, it is unlikely that we will capture all the abbreviations in literature articles by applying AbbRE alone; other approaches need to be integrated.

We explored mapping undefined abbreviations to four abbreviation databases—GenBank LocusLink, SWISSPROT, LRABR, and BioABACUS. However, an average of only 68 percent of the undefined abbreviations could be mapped to any of four databases. Our results suggest that the four databases we tested do not provide exhaustive coverage and that we would need a more comprehensive abbreviation database to map undefined abbreviations effectively.

AbbRE itself may therefore be used to create a more comprehensive abbreviation database, either by applying it to a large body of electronic articles or to all the MBDLINE abstracts in PubMed, under the assumption that abbreviations are usually defined in the abstracts when they are first introduced into the literature. Another assumption is that even though not all the abbreviations in an article are defined in the abstract, they might be defined in the abstracts of other articles.

Our results indicate another obstacle to mapping undefined abbreviations to an abbreviation database: Some abbreviations have more than one full form. Abbreviations that have many forms are common. Abbreviations are not well standardized in medical, biological, or pharmaceutical science; each scientist uses his or her own judgment in choosing abbreviations. For example, in medicine, PID stands for both pelvic inflammatory disease and prolapsed intravertebral disc.

Although researchers are working to standardize medical and biological abbreviations, the standardization is limited to specific domains, such as cardiology or vertebrate virus species. Therefore, the same abbreviation may become ambiguous when we search across several domains. For example, in molecular biology, CAT means chloramphenicol acetyl transferase; in computer science, ‘it means computer-aided testing; in cell biology, it means computer-automated tomography; and in medicine, it means computed axial tomography. Disambiguating an abbreviation is a case of word sense disambiguation, the problem of resolving semantic ambiguity. There are many computational linguistic approaches, including lexicon and corpus-based approaches, to disambiguating the meaning of words. Most approaches, however, target the general English word, such as batik. Machine-learning techniques may be applied for disambiguating symbols to determine whether they represent proteins, genes, or RNA, However, the approach does not identify the meanings (or the full forms) of gene or protein symbols.

The knowledge domain to which an abbreviation belongs identifying may thus be identified since there are fewer ambiguous abbreviations within a knowledge domain than across knowledge domains. Thus, identifying the knowledge domain to which an abbreviation belongs may disambiguate the abbreviation. This approach requires a database that contains not only the abbreviation and its concept but also the knowledge domain.

One way to obtain the knowledge domain is to assign MeSH concepts to paired abbreviations and full forms. Each MEDLINE article has manually indexed MeSH concepts. The assigned MeSH concepts usually define the knowledge domain of its article. Therefore, the abbreviations used in the article are within the scope of the list of MeSH concepts. AbbRE may be used to extract defined abbreviations in abstracts, as well as the list of MeSH concepts indexed to the articles. (Assigned MeSH concepts are available in electronic format along with the abstracts.)

When a particular abbreviation is not defined in an article, we may map this abbreviation, as well as the list of MeSH concepts indexed to the article, to the abbreviation database developed, by using AbbRE to determine the actual meaning of the abbreviation. In addition, context-based disambiguation may also be a way to disambiguate abbreviations.

Another approach to identifying the full forms of undefined abbreviations is to link the abbreviations to citations to the articles in which they appear, to references in the articles in which they appear, and to related articles; all functions are provided by PubMed. The assumption is that all the abbreviations must be defined in the articles when the abbreviations are first introduced in literature, and those articles may be listed in the citations. Both citation and related-articles approaches were applied and evaluated to sufficiently improve information retrieval in other systems.

Our results indicate that AbbRE may enhance information retrieval by two means. First, AbbRE may be used to recognize the full forms of defined abbreviations; full-form recognition may increase term frequency, a measurement widely used in information retrieval, when the full form is used as the search term. The rationale is that we expect less occurrence of a full form in the article when its abbreviation is used in the article. Second, AbbRE may be used indirectly to recognize the full forms of undefined abbreviations, in that AbbRE may be applied to create an exhaustive abbreviation database, which may be used to map undefined abbreviations. The abbreviation database seated by AbbRE may further facilitate abbreviation disambiguation.

We used the opinions of domain experts to evaluate the performance of AbbRE. Developing analyzers that yield a conceptual representation of biomedical narratives has long been a research topic in biomedical informatics. In order to validate the usage of the program, evaluation is a necessary step and a reference standard is needed for an evaluation. Usually, domain experts are chosen for that purpose. However, domain experts are human and therefore may be error prone themselves. In order to be fair to the computer program, we determined the reference standard by having experts re-evaluate pooled selections from both the experts and the AbbRE output.

Overall agreement was measured to indicate the experts' agreement. Results showed that the overall agreements were different for defined abbreviations and undefined ones. For example, the over-all agreements in the selection of defined abbreviations in both part A and part B evaluations were all above 0.70, and the overall agreements in the part B evaluation reached 0.88 and 0.94 for medical and biological articles, respectively. However, the overall agreements of both medical and biological experts in selecting undefined abbreviations were lower (0.42 and 0.40, respectively). The results indicated that experts are more likely to agree on defined abbreviations than on undefined abbreviations.

The results are consistent with the frustration many experts expressed in identifying whether a term was art abbreviation or a symbol. For example, experts disputed “pi,” “NiC12S12,” and “stage UT” as abbreviations. Our results also indicate that the overall agreements among both medical and biological experts after pooled abbreviations were higher than before pooled abbreviations, and that the overall agreements in validating an abbreviation in part B of the evaluation were higher than the overall agreements in selecting an abbreviation in part A of the evaluation; the results suggest that experts agreed more in validating an abbreviation than in finding an abbreviation.

In one embodiment, the AbbRE maps names with abbreviations using one or more of the following phases: 1) Mapping phase: mapping abbreviations, such as gene/protein symbols, to full names. 2) Generating a knowledge source, e.g., database, of paired abbreviations and full forms from, e.g., MEDLINE abstracts, or any other text corpus. 3) Filtering phase: filtering out other abbreviation-full form pairs to produce a knowledge source of paired gene/protein symbols and full names. 4) Marking up phase: applying the knowledge source of paired abbreviations and full forms to mark up gene/protein terms and to map the symbols to full names. 5) Evaluating GPmarkup. 6) Measuring the percentage of defined gene/protein symbols in MEDLINE abstracts.

Marking up gene/protein of the present invention generally uses a knowledge-based approach, which dynamically applies cues for identifying automatically gene/protein terms. The method may also include automatically generating a knowledge source of paired gene/protein symbols and full names from MEDLINE and using the knowledge source to mark up the remaining terms.

Natural language processing (NLP) techniques are used to extract knowledge automatically from computer-readable literature. In biology, the identification of terms corresponding to biological substances (e.g., genes and proteins) is a necessary step that precedes the application of other NLP systems that extract biological knowledge (e.g., protein-protein interactions, gene regulation events, and biochemical pathways). The present invention provides GPmarkup (for “gene/protein-full name mark up”), a software system that automatically identifies gene/protein terms in MEDLINE abstracts. As a part of marking up process, a knowledge source of paired gene/protein symbols and full names (e.g., LARD for lymphocyte associated receptor of death) is also generated automatically from MEDLINE. Many of the pairs in our knowledge source do not appear in GenBank LocusLink. Therefore our methods may also: be used for automatic lexicon generation.

MEDLINE database includes a dozen million computer-readable abstracts in the biomedical domain; it is a rich resource for biological knowledge including protein-protein interactions, gene regulation events, sub-cellular locations of proteins, and pathway discovery. One way to automatically unlock the knowledge stored in MEDLTNE is to apply a full parser such as GENES that extracts and structures information about cellular pathways. Identifying gene/protein terms in MEDLINE abstracts is a necessary step that precedes the application of GENES.

The presents invention provides a method for automatic identification of gene, and protein terms in MEDLINE abstracts. As a part of methodology for automatic marking up, a method is presented for automatic generation of a knowledge source of paired gene/protein symbols (e.g., LARD) and full names (e.g., lymphocyte associated receptor of death) from MEDLINE. Our results show that a large number of the pairs in our knowledge source do not appear in Genbank LocusLink, a pubic database of gene/protein symbols and full names.

Genes and proteins are usually represented by symbols and names in literature. The names usually are the long forms of their symbols and describe the functions of the genes or proteins. Some authors define gene/protein symbols in literature and the definitions can be captured by a computer program. Even though not all the authors define their gene/protein symbols and not all the gene/protein symbols appear in abstracts are defined, literature redundancy (e.g., the same genes or proteins are represented by different authors in different articles) makes it feasible that we may obtain automatically a relative exhaustive gene/protein symbols and full names from all MEDLINE records. In this study, we empirically tested all of the above hypotheses.

As noted above, the present invention provides a method that automatically maps biomedical abbreviations to full forms. We incorporated biological domain knowledge into the method of mapping abbreviations to full forms to enhance the mapping between gene/protein symbols and full names. The biological domain knowledge was obtained from manually reviewing published guidelines of the nomenclature of genes and proteins. We then developed a method to differentiate paired gene/protein symbols and full names from other biomedical abbreviations and full forms.

To mark up gene/protein terms in MEDLINE abstracts, we first mark up gene/protein symbols and full names when the full names are defined. We then look up a knowledge source to mark up the remaining gene/protein terms. We generate the knowledge source by extracting all pairs of gene/protein symbols and full names from over eleven million MEDLINE records (year 1966-2001).

Mapping Phase: mapping gene/protein symbols to full names—We started with the analysis of guidelines for mapping gene/protein symbols to their complete full names. To understand how gene/protein abbreviation-full names are created in the first place, we examined a number of published guidelines for the nomenclature of genes and proteins (see Table D). Unfortunately, these guidelines are almost always species-specific (that is applicable only to genes and proteins from, say, yeast and not rat) because the committees for the nomenclature are formed by experts specializing on a particular model organism. Analysis of the published guidelines allowed us to identify some special abbreviations that are used for gene/protein nomenclature (see Table E) and to develop the pattern-matching rules that map gene/protein symbols to names.

TABLE D
A subset of guidelines that are useful for applying computational
approaches to map a gene or a protein symbol to its full name

| | |
|---|---|
| 1. | A gene symbol should stand for a description of a phenotype, a gene |
| | product or a gene function |
| 2. | A gene symbol shall be short (between three to six characters. |
| 3. | A gene symbol is an abbreviation of its full name. |
| 4. | If the symbol of a gene contains a character or property for which |
| | there is a recognized abbreviation, the abbreviation should be used; |
| | for example, the single-letter abbreviation for amino acids used in |
| | aminoacyl residues or approved biochemical Abbreviations such |
| | as GLC for glucose, GSH for glutathione and Bp for binding protein. |
| 5. | The initial character should always be a letter. |
| 6. | All Greek symbols should be changed to letters in the Latin alphabet. |
| 7. | Amino acids have their special symbols. |
| 8. | The protein symbol is the same as the gene symbol. |
| 9. | The creation of a gene full name shall follow the guidelines and get |
| | consultation from curator of the guideline before journal publication. |
| 10. | Gene full names are encouraged to be included in the abstracts |
| | of any relevant papers. |

TABLE E
Special abbreviations that are used in gene/protein nomenclature

| Type | Examples |
|---|---|
| Amino | tyrosine-Y; For example, SY(˜for spleen tyrosine kinase |
| acids | |
| Chemical | Sodium-Na, potassium-K; For example, V11 AIF for |
| symbols | sodium-potassium potassium ATPase inhibitory factor |
| Others | Inhibitor-N or NH, box-X; For example, CDKNIA |
| | for cyclin-dependent kinase inhibitor IA (p21, Cipl), CDX1 |
| | for caudal type homeo fox transcriptiol factor 1 |

Pattern-matching rules—GPmarkup may be built on AbbRE algorithm with the following modifications and extensions to the rules noted above. Rule 1: Any number and special character is ignored for mapping gene/protein symbols to full names. We added in a rule to map letters only. We ignored numbers and special characters, (e.g., “+”) due to the following two reasons: (1) Many numbers and special characters in a gene or a protein symbols do not appear in their full names. For example, CYP2C19 for cytochrome P4S0, subfamily IIC (mephenytoin 4-hydroxylase), where “19” is not represented and “2” is represented by “II”. (2) Many numbers in gene or protein symbols order differently in their full names (e.g., ALOX12 for arachidonate 12-lipoxygenase, where “12” in the symbol “ALOX12” is after “LOX” that represents lipoxygenase, but before “lipoxygenase” in the full name “arachidonate 12-lipoxygenase”). Rule 2: Substitution rules—We substitute some nouns with their special abbreviations when we apply the pattern-matching rules, For example, instead of mapping DYRKIA to dual-specificity tyrosine phosphorylation regulated kinase IA, we map DYRKIA to dual-specificity Y phosphorylation regulated kinase IA, where tyrosine has been replaced by Y. If the mapping is successful, we recover the original terms.

In reality, not all the authors use the special abbreviations for their nomenclature. An example is PTK2B for protein tyrosine kinase 2 beta, where tyrosine is represented by its common abbreviation T instead of Y. Therefore, our algorithm considers both types of mapping (with and without substitution of a special noun with a shorthand) and selects the best matching version. For example, we map PTK2B to both protein tyrosine kinase 2 beta and protein Ykinase 2 beta; we map DYRKIA to both dual-specificity tyrosine phosphorylation regulated kinase IA and dual-specificity Yphosphorylation regulated kinase IA. When a full form has more than one word that has many abbreviations, we include all of the combinations for substitution. For example, in case of NKAIWF for sodium potassityn ATPase inhibitory factor, we map NKAIF to sodium potassium ATPase inhibitory factor, Na-potassium, ATPase inhibitory factor, sodium-K ATPase inhibitory factor, and &-K ATPase inhibitory factor.

Parenthetic pattern—In one embodiment, the method/system (AbbRE) uses specific patterns such as “<abbreviation>(<full form>)” or “<full form(<abbreviation>)” to recognize candidate abbreviations and full forms and then applies the pattern-matching rules to map abbreviations to full forms. It follows that AbbRE cannot recognize gene/protein terms that incorporate parentheses. For example, AbbRE recognizes a protein full name-abbreviation pair (actin-related protein 1, yeast) homolog A (centractin alpha) (ACTRIA) as three different candidate abbreviations because the string incorporates three pairs of parentheses. To correct for this shortcoming, an additional rule is used to recognize gene/protein full names that incorporate parentheses: For example, Gpmarkup parses the string “we found that (actin-related protein 1, yeast) homolog A (centractin alpha) (ACTRIA) has a role in . . . ” into the following three components:
we found that (actin-related protein 1, yeast),
we found that actin-related protein 1, yeast homolog A (centractin.alpha), and
we found that actin-related protein 1, yeast homolog A centractin alpha (ACTRIA) where the text preceding and within the parentheses in each component incorporate candidate abbreviations and full forms, which GPmarkup further applies its pattern-matching rules to map abbreviations to full forms.

Generating A Knowledge Source of Paired Abbreviations/Full Forms from MEDLINE Abstracts—GPmarkup is applied to eleven million MEDLINE records (1966-2001), which contain the same number of titles and over six million abstracts (note that not all MEDLINE records contain abstracts). From titles and abstracts, we obtained a knowledge source that consisted of 574,327 unique pairs of abbreviations and full forms. The most frequently defined abbreviations were PCR (polyrnerase chain reaction, which appeared in 7,988 abstracts) and NO (nitric oxide, which appeared in 7,855 abstracts).

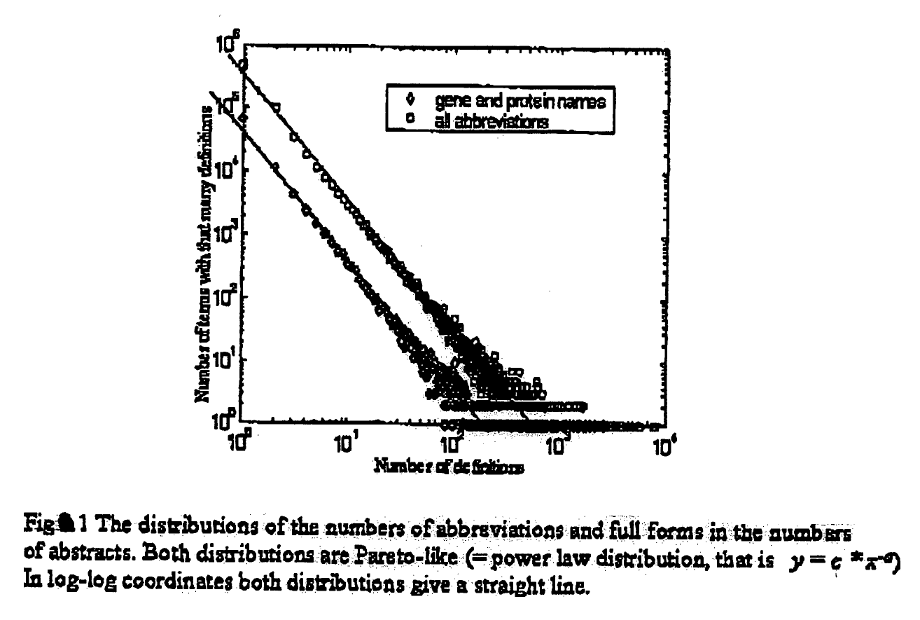

FIG. 1 plots the frequency of abbreviation-full form pairs that appear in different abstracts. Note that the distribution of the numbers of the pairs follows a power law (+Pareto) distribution (y=c*x^{a}). This indicates that the abbreviation-full form knowledge source exhibits the same statistical patterns as general vocabulary of a language, but, unlike the general vocabulary, can be easily analyzed in.terms of temporal dynamics (i.e., time axis can be readily added into the distribution).

Filtering Phase: filtering Out Other Abbreviation-Full Form Pairs To Produce A Knowledge Source Of Paired Gene/protein Symbols and Full Names—The algorithm outlined above also identifies a large number of general abbreviations that are not gene/Protein symbols and full names. We therefore developed a rule-based approach to partition our knowledge source of abbreviation-full form pairs into gene/protein symbol-full name pairs and other abbreviation-full form pairs.

Our rule-based approach combines morphological cues, functional keywords, and position-functional keywords to filter out non-gene/protein terms. The approach is described as follows:

If an abbreviation contains a number, the abbreviation and full form is a gene/protein symbol-full name pair only if the full name contains one or more of the following keywords (denoted as set Ki): protein(s), gene(s), peptide(s), molecule(s), enzyme(s), ligand(s), compound(s), receptor(s), kinase(s), channel(s), transcriptor(s), regulator(s), inhibitor(s), antibody, antibodies, globulin(s), factor(s), motif, domain(s); compound(s), segment(s), subunit(s), locus, loci, cassette(s), chain, complex(es), homeobox(es), box(es), member(s), deletion, axon, family, families, chromosome(s), sequence, alpha, beta, gamma, interleukin and any words except for disease that ends in—ase.

If an abbreviation does not contain a number, the abbreviation and full form is gene/protein symbol-full name pair only if the last word of the full form is a keyword in set K1.

Note that some keywords (e.g., “gene”) in set K1 can appear as both the last word or the middle word of a gene/protein term (e.g., Btg4 for B-cell translocation gene 4 and AFG3L1 for AFG3 (ATPase fancily gene 3, yeast)-like 1). On the other hand, some keywords (e.g., “chromosome”) do not appear as the last word of, but only within a gene/protein term (e.g., C100RF2 for chromosome 10 open reading frame 2).

Based on this rule-based approach, we generated a knowledge source of 86,767 unique pairs of gene/protein symbols and names from the knowledge source of paired abbreviations and full forms. The most frequently defined gene/protein symbols included egf (for epidermal growth factor, appears in 2,023 abstracts), it (for interleukin, appears in 2,183 abstracts), and 1 dl (for low density 1 ipoprotein, appears in 2,673 abstracts). FIG. 1 plots the relation of the numbers of gene/protein symbols and full names that appeared in different numbers of abstracts. Note that the distribution of the numbers of associated gene/protein, symbols and full names in the numbers of abstracts also follows power law distribution (y=c*x^{a})

Marking Up Phase: Applying the Knowledge Source of Paired Abbreviations And Full Forms to Mark Up Gene/Protein Terms And to Map the Symbols to Full Names—We further developed and implemented an algorithm to mark up gene/protein terms in MEDLINE abstracts. GPmarkup first maps abbreviations to full forms and then performs the markup for any abbreviation with an identified full form. Using the knowledge sources of paired abbreviations and full forms and paired gene/protein symbols and names, GPmarkup marks up the remaining gene/protein terms in the abstracts.

When a string can be mapped to several terms stored in our knowledge sources, GPmarkup favors longer term mapping and markup. For example, GPmarkup does not falsely mark up a protein term amyloid beta protein in a string of cerebral amyloid beta protein angiopathy, which GPmarkup identifies as a term that is not a gene or a protein full name.

GPmarkup applies direct matching except that it includes a word that immediately follows a gene or a protein symbol or full name if the word either consists of a number or is a functional keyword including “gene,” “protein,” “homologue,” and “receptor.” For example, knowing abeta and i 112 p40 as gene or protein symbols, GPmarkup also identifies abeta 4O and 1112p40 homologue.

GPmarkup Evaluation—Since GPmarkup has several phases: 1) Mapping phase: mapping abbreviations to full forms, 2) Filtering phase: filtering out other terms to produce a knowledge source of paired gene/protein symbols and names, and 3) Marking up phase: marking up gene/protein terms in MEDLINE abstracts. We therefore evaluate GPmarkup phase by phase. We also compared the knowledge source of paired gene/protein symbols and full names with the ones in GenBank LocusLink.

Mapping phase evaluation—Based on independent experts' judgment, we measured the recall and precision of GPmarkup in mapping abbreviations to full forms when the full forms are defined in 30 randomly (by time of publication) selected MEDLINE abstracts. GPmarkup correctly mapped 56 abbreviations and full forms out of a total of 59 abbreviations and full forms that were manually identified by three, biological experts (all of them with PhD degree in biology). The gold standard was determined by a majority vote of experts. GPmarkup wrongly identified one pair that was not an abbreviation and full form. GPmarkup's recall and precision in identifying and extracting abbreviations and full forms were 94.9% (56/59) and 98.2% (56/57), respectively.

Filtering phase evaluation—Based on the authors' judgment, we evaluated our rule-based approach for partitioning the knowledge source of abbreviation-full form pairs into gene/protein symbol-full name pairs and other abbreviation-full form pairs. We randomly selected 1,000 pairs of gene/protein symbols and full names and 1,000 pairs of other abbreviations and full forms partitioned by GPmarkup and evaluated recall and precision of the partitioning. Table F lists the results of the evaluation. Note that GPmarkup included some incorrect pairs of abbreviations and full forms (e.g., {il-6, interleukin} and {gene,genes}). Since the number ratio of gene/protein symbol-name to other abbreviation-full form pairs was 1:5.6 (86,767/574,327−86,767; the numbers were described in sections 3.2 and 3.3), GPmarkup had 95.4% accuracy (982+949*5.6/1000+1000*5.6) in partitioning the knowledge source of paired abbreviations and full forms into gene/protein symbol-full name pairs and other abbreviation-full form pairs.

TABLE F
Evaluation results of GPmarkup in filtering the
knowledge source of paired abbreviations and full
forms to produce a knowledge source of paired
gene/protein symbols and full names

| | Evaluation results | | |
|---|---|---|---|
| | | Number of | |
| | Number of | other | Number of |
| | gene/ | abbreviation- | non-abbreviation- |
| Evaluation | protein symbol- | full | full |
| cases | full name pairs | form pairs | form pairs |
| 1,000 pairs of | 982 | 9 (e.g., srg | 9 (e.g., gene for |
| gene/ | | for spent | genes) |
| protein | | | |
| symbols | | | |
| and full | | | |
| names as | | | |
| identified by | | | |
| Gpmarkup | | | |
| 1,000 pairs | 1 (i.e., A-Igg for | 949 | 50 (e.g., ph2 |
| of other | Anti-human Igg) | | for phages) |
| abbreviations | | | |
| and full | | | |
| forms as | | | |
| identified | | | |
| by GPmarkup | | | |

Marking up phase evaluation—GPmarkup was evaluated in marking up gene/protein terms in MEDLINE abstracts. We randomly (by time of publication) selected 50 MEDLINE abstracts, which consists of a total of 539 sentences (including the title). Table 3.5 lists the evaluation results of the 50 abstracts. GPmarkup applies XML format for term mark up. For example, the tag “phr” (for “phrase”) has attributes including “sem” (for “semantic category”) that has value “gp” (for “gene and protein terms”) and “t” (for “target”) that represents gene/protein full names. We count any appearance of gene/protein terms. For example, if protein “amyloid beta protein” appears three times in the abstract, we count three instead of one for this case.

TABLE G
Evaluation results of GPmarkup

| | Gpmarkup |
|---|---|
| Type of category | identified |
| Complete-matching (e.g., <phr sem = “gp” t= “signaling | 222 |
| lymphocyte activationmolecule” >slam</phr> | |
| Partial-matching* (e.g., <phr sem = “gp” >interleukin 1</ | 15 |
| phr> receptor ii) | |
| Missing (e.g., 2b4) | 88 |
| False-matching** (e.g., <phr sem = “gp”>acupuncture | 17 |
| points and channels</phr>) | |

*The correct full name is “interleukin 1 receptor ii”
**False-matching includes those non-gene and non-protein terms that are identified by GPmarkup

From Table G, if we count a partial-matching as a match, the recall and the precision of GPmarkup were 73% (222+15/222+15+88) and 93% (222+15/222+15respectively. If we, do not include a partial-matching as a match, the recall and precision of GPmarkup were 68% (222/222+15+88) and 87% (222/222+15+17 ), respectively.

Comparing gene/protein symbols and full names extracted from MEDLINE with GenBank LocusLink—We downloaded the knowledge source of paired gene/protein symbols and full names (stored in LL.out file) from GenBank LocusLink. GenBank LocusLink is maintained by the NCBI (National Center for Biological Information). It presents information on Official nomenclature of genes. LL.out file includes paired gene symbols and full names. We found that LL.out contains a total of 115,890 entries, of which 65,987 entries have both gene/protein symbols and fall names; the rest of entries have only one of them.

We randomly selected 100 entries that incorporate both symbols and full names from the LL.out file and manually identify their existence in our knowledge source of paired gene/protein symbols and full names. We also randomly selected 100 unique gene/protein symbol and full name pairs from our knowledge source and manually identified their existence in LL.out file.

We found that 60 out of 100 LL.out entries could not be found in our knowledge source of paired gene/protein symbols and full names. We judged that four of those 60 entries are not gene/protein symbols and full names (e.g., shsisutherland-haan x-linked mental retardation syndrome); 29 entries do not agree with our pattern-matching rule “the first letter of abbreviations map the first letter of full forms (e.g., 2700088m22rikIriken cdna 2700088m22 gene); the rest of 27 entries did not appear in our knowledge source (e.g., eig7leblecdysoneinduced gene 71eb). Out of 40 LL.out entries that could be found in our knowledge source, 16 of them have some variations. For example, we found in our knowledge source “HMG-lp/high mobility group protein” that matches LL.out “HMGlIp/high-mobility group (nonhistone chromosomal) protein 1 pseudogene.”

Sixty-two out of one hundred pairs in our knowledge source did not appear in LL.out. Examples included “CCK-OPlcholecystoicinin octopeptide” and “1-PKf 1 pyruvate kinase.” Eight out of thirty eight that were matched contain variations. For example, “PPIlpeptide prolyl cis trans isomerase” appear in our knowledge source. In LL.out, we found “PPIalpeptidylprolyl isomerase a (cyclophilin a).”

The Percentage of Undefined Gene/Protein Symbols and Full Names—If all the gene/protein symbols and full names are defined in MEDLINE abstracts, then GPmarkup also serves the purpose for disambiguation by assigning full names to symbols. However, not all the gene/protein symbols are defined in the abstracts.

The percentage of defined gene/protein symbols in MEDLINE abstracts were therefore measured. We randomly select 100 abstracts (according to the time of publication) from a total of 782,560 MEDLINE abstracts (1966-2001) that were retrieved by the keyword “protein.” Those abstracts contain 1,069 sentences (including titles). We measured the percentage of undefined gene/protein symbols. We counted unique appearance of gene/protein symbols within abstracts. Based on the authors' judgment, the numbers of defined and undefined gene/protein symbols were 92 and 27, respectively. The percentage of defined gene/protein symbols and full names was 77%.

Although we do not differentiate a gene term from a protein term when the tern meaning is ambiguous, one can attempt to disambiguate gene/protein terms. This hypothesis is based on the following sub-hypotheses: 1) authors define gene/protein symbols when they are new in literature; 2) authors also define gene/protein symbols for clarity since gene/protein symbols could be ambiguous (for example, aap denotes alkyl acceptor protein, amino acid permease, antiarrhythmic peptide, antimicrobial anionic peptide and atrial peptide depending on the context); 3) in addition, since literature contains redundant information (e.g., the same genes or proteins are represented by different authors in different articles), even if some authors do not define their genes or proteins, we may still find the definitions of the same genes or proteins in other articles.

Many public databases such as Genbank and SWISSPROT have gene/protein synonym knowledge sources. However, the databases are largely maintained manually and therefore are not always up to date. GPmarkup can generate automatically a knowledge source of paired gene/protein symbols and full names from MEDLINE abstracts. The automated fashion may reduce manual efforts. In addition, GPmarkup may capture the most up-to-date gene/protein symbols and full names if the full names are defined in abstracts and follow the guidelines of nomenclature of genes and proteins. Note that we recognized a gene/protein term if the term actually represents a gene/protein in the abstract. We described earlier that we did not mark up “cerebral amyloid beta protein angiopathy” as a protein name even though “cerebral amyloid beta protein” by itself is a protein name. Other researchers may do differently.

One limitation of GPmarkup is that not all the gene/protein symbols and full names are defined in the abstracts and therefore GPmarkup may not capture some gene/protein symbols and full names. However, two other factors alleviate this problem: authors are encouraged to define gene/protein full names in the abstracts of any relevant papers (Kohli 1987), and the literature is redundant. Therefore, applying GPmarkup to all of MEDLINE abstracts is likely to capture a majority of gene/protein symbols and full names.

GPmarkup may also miss gene/protein symbols and full names when authors do not follow the guidelines for naming genes and proteins. To capture these gene/protein symbols and full names, we may integrate into GPmarkup statistical approaches of selecting phrases associated with parentheses that were statistically significant. In addition, GPmarkup may also miss abbreviations and full forms that are introduced through syntactic patterns (e.g., appositions). In the near future we plan to utilize the approaches that enumerated syntactic patterns for abbreviation detection.

Other limitations include the ambiguity and usage of gene/protein terms. Earlier we have explained the ambiguity between a gene term and a protein one. Other questions are to which organism, tissue, cell type, and sub-location a gene/protein term refers. In addition, GPmarkup also includes general gene/protein terms (e.g., growth factors), In the near future, we hope to,' develop statistical NLP approaches for further disambiguation.

Our rule-based approach outperformed the machine-learning one in separating gene/protein full names from other biomedical full forms. The results can be attributed to the fact that genes and proteins are highly related to other biological terms (e.g., small molecules, chemicals, sub-locations, families, cell types, tissues, and species) and any machine-learning approach that uses surrounding words as features will have difficulty in classifying genes and proteins from other biological terms. We may improve the classification by incorporating functional relations. For example, many biological actions (e.g., translate) specifically apply to proteins. We may also improve the classification through morphological cues and part-of-speech techniques. We may apply the machine-learning approaches to classify the remaining terms that failed to be classified by GPmarkup to increase the recall of GPmarkup.

Our study shows that many gene/protein symbols (78%) are defined within the abstracts, GPmarkup can map a majority of gene/protein symbols to full names. GPmarkup does not mark up undefined gene/protein symbols if the symbols have several full forms in the knowledge source of abbreviation-full form pairs. For example, gap denotes antiarrhythmic peptide, alkyl acceptor protein, Alzheimer amyloid precursor protein, aminoantipyrine, and automatic action potential in our knowledge source and GPmarkup thus does not mark up “sap” as a gene/protein term when it is not defined in the abstract. We therefore sacrifice GPmarkup's recall for high precision. To increase the recall, we may integrate a disambiguation method that assigns the full forms from our knowledge source to the ambiguous symbols.

In addition, our results indicate that the statistical distribution of abbreviations in MEDINE abstracts displays scale-free properties (see FIG. 1). The plot for all abbreviations and full forms appears as a nearly perfect straight line in log-log coordinates, which indicates that the system evolves in time following a “rich get richer” model. That the probability that a reference will be used again is proportional to the number of times the abbreviation was used before, which creates a situation where a few abbreviations are used an astronomical number of times, while the majority of abbreviations are used rarely or just once. This observation may have important implications in curation of gene/protein full name vocabulary: such curation should start from the most abundant abbreviations and move towards low-representation end of the spectrum: in this way the impact of any given amount of work can be maximized with respect to any applications of knowledge source to analyze the actual text. Indeed, correction of single term at the abundant end of the spectrum can improve the performance of a knowledge-based text-processing application in the same degree as correction of errors in thousands of abbreviations at the scarce end of the spectrum.

While the foregoing invention has been described in some detail for purposes of clarity and understanding, it will be appreciated by one skilled in the art, from a reading of the disclosure, that various changes in form and detail can be made without departing from the true scope of the invention in the appended claims.

1. A method for mapping biological abbreviations with biological names comprising
processing a document comprising at least one biological abbreviation to identify a parenthetical expression and a phrase preceding the parenthetical expression which are used as a candidate abbreviation and full form of the biological abbreviation;
detecting a biological abbreviation contained in one of the parenthetical expression and the phrase preceding the parenthetical expression; and
determining whether one of the parenthetical expression and the phrase preceding the parenthetical expression contains a full form of the detected biological abbreviation based on a plurality of pattern matching rules designed for mapping abbreviations to their full forms.

2. The method of claim 1, comprising determining the full form of the abbreviation using at least one public abbreviation database when the biological abbreviation is not defined in the at least one document.

3. The method of claim 1, wherein the plurality of pattern matching rules designed for mapping abbreviations to their full forms comprises at least two of:
1) the first letter of an abbreviation matches the first letter of a meaningful word of the full form;
2) the abbreviation matches the first letter of each word in the full form;
3) a word in the full form can be skipped if the abbreviation letter matches the first letter of the following word;
4) the abbreviation letter matches consecutive letters of a word in the full form; and
5) the abbreviation letter matches the last letter of a word in the full form if the letter is an s and if the first letter of the word matches the abbreviation.
6) the abbreviation letter matches a middle letter of a word in the full form if the first letter of the word matches the abbreviation.

4. The method of claim 3, comprising applying rules 2, 3, 4, 5, and 6 in that order until the abbreviation is completely matched with the full form.

5. The method of claim 1, wherein the document comprises at least one of a common abbreviation and a dynamic abbreviation.

6. The method of claim 1, comprising processing the document to remove tags and parentheses that are not associated with abbreviations.

7. The method of claim 6, comprising parsing the document into sentences and processing only the remaining sentences that contain parentheses.

8. The method of claim 7, comprising parsing at least one of the remaining sentences that contain parentheses into a first component comprising text within the parentheses and a second component comprising text preceding a left parenthesis.

9. The method of claim 8, wherein the step of detecting at least one biological abbreviation comprises detecting abbreviations in one of the first component and the second component.

10. The method of claim 9, wherein the step of detecting abbreviations in the first component comprises partitioning the first component comprising a punctuation mark, and extracting text of the first component to the left of the punctuation as an abbreviation.

11. The method of claim 9, wherein the step of detecting abbreviations is based on an assumption that an abbreviation consists of only one word and that an abbreviation is shorter than its full form.

12. The method of claim 9, wherein the step of detecting abbreviations comprises determining if the first component contains more than one word, if so, assuming the first component comprises a potential full form, and the word before the left parenthesis is a potential abbreviation.

13. The method of claim 1, comprising identifying a particular knowledge domain to which an abbreviation belongs and determining the full form of the abbreviation using at least one public abbreviation database specific to the particular knowledge domain.

14. The method of claim 13, wherein the document comprises at least one concept assigned thereto that defines the particular knowledge domain of the document and wherein the particular knowledge domain is identified using the at least one concept.

15. The method of claim 1, comprising determining the full form of the abbreviation using at least one public abbreviation database comprising at least one article cited in the document, wherein the full form of the abbreviation is determined based on definitions contained in the cited article.

16. The method of claim 1, comprising determining the full form of the abbreviation based on a plurality of pattern matching rules designed for mapping at least one of gene and protein abbreviations to their full forms.

17. The method of claim 16, comprising:
processing the document to remove tags and parentheses that are not associated with abbreviations;
identifying sentences that contain a plurality of parentheses pairs; and
parsing sentences that contain the plurality of parentheses pairs into at least three components where text preceding and within the parentheses in each component incorporate candidate abbreviations and full forms.

18. The method of claim 16, comprising generating a database of abbreviations paired to full forms.

19. The method of claim 18, comprising marking up a corpus of documents using the database of abbreviations paired to full forms.

20. A method for mapping biological abbreviations with biological names comprising:
processing a document comprising at least one biological abbreviation;
parsing the document into sentences and identifying sentences that contain parentheses;
parsing at least one of the sentences that contain parentheses into a first component comprising text within the parentheses and a second component comprising text preceding a left parenthesis;
detecting a biological abbreviation contained in one of first component and the second component; and
determining whether one of the first component and the second component contains a full form of detected biological abbreviation using a plurality of pattern matching rules designed for mapping abbreviations to their full forms.

21. A method for mapping biological abbreviations with biological names comprising
processing a document comprising at least one biological abbreviation;
parsing the document into sentences and identifying sentences that contain parentheses;
parsing sentences that contain a plurality of parentheses pairs into at least three components where text preceding and within the parentheses in each component incorporate candidate abbreviations and candidate full forms;
detecting at least one biological abbreviation contained in one of the at least three components; and
determining whether one of the at least three components contains a full form of detected biological abbreviation using a plurality of pattern matching rules designed for mapping at least one of gene and protein abbreviations to their full forms.
